(19) United States
(12) Patent Application Publication
(10) Pub. No.: US 2005/0047976 A1
(43) Pub. Date: Mar. 3, 2005

(54) Method and apparatus for solid or solution phase reaction under ambient or inert conditions

(76) Inventors: Klaus Gubernator, Del Mar, CA (US); Joseph Cohn, Carlsbad, CA (US); Andrew Patron, San Diego, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 10/466,867

(22) PCT Filed: Jan. 25, 2002
(86) PCT No.: PCT/US02/01927

Related U.S. Application Data
(60) Provisional application No. 60/263,762, filed on Jan. 25, 2001.
(60) Provisional application No. 60/300,103, filed on Jun. 25, 2001.

(51) Int. Cl. B01J 19/00

(52) U.S. Cl. 422/130

(57) ABSTRACT

The present invention generally provides a novel, automation-compatible solid or solution phase reaction vessel, as well as methods for using such a vessel. Generally, the reaction vessel comprises a microplate assembly with a modular solid phase included within the individual reaction wells. The reaction vessel of the invention allows for the integration of solid phase chemistry with the processing abilities of solution phase chemistry. According to the invention, the microplate assembly and the solid phases are configured so as to integrate together into a single reaction vessel. The combination enables solid phase reactions in a single vessel with full compatibility to liquid handling automation. Further, the combination enables novel methods for performing combination solution phase/solid phase reactions under inert conditions.

### CROSS REFERENCE TO PRIOR APPLICATIONS

The present application claims priority to U.S. Provisional Application Ser. No. 60/263,762 filed Jan. 25, 2001, and to U.S. Provisional Application Ser. No. 60/300,103 filed Jun. 25, 2001. The contents of both Provisional Applications are hereby incorporated by reference in their entirety.

### FIELD OF THE INVENTION

The present invention relates generally to an apparatus and method for chemical synthesis. More particularly, the present invention relates to an apparatus and method for high-throughput, solid or solution phase organic synthesis. The invention also relates to a microtiter chemical system particularly suitable for the apparatus and method of the invention.

### BACKGROUND OF THE INVENTION

Combinatorial chemistry generally relates to a set of techniques for creating a multiplicity of compounds and then testing them for desired activity. More specifically, combinatorial chemistry involves the formation of large libraries of molecules en masse, instead of the synthesis of compounds one by one as had been done traditionally. Once the libraries are obtained, the most promising lead pharmaceutical compounds are identified by high-throughput screening for further evaluation.

Generally, combinatorial compounds are created either by solution-phase synthesis or by producing compounds bound covalently to solid phase particles. Solid phase synthesis can make multi-step reactions easier to perform and more reliably allows one to drive reactions to completion because excess reagents can be added and then easily washed away after each reaction step. Further, solid phase synthesis allows for the use of split synthesis, a technique that produces large support-bound libraries in which each solid phase particle holds a single compound. Soluble libraries can then be produced by cleavage of the compounds from the solid support. Nonetheless, a much wider range of organic reactions can be available for solution phase synthesis, and products in solution can often be more easily identified and characterized. As such, solution phase synthesis can still be preferable in some situations.

Regardless of the method employed, combinatorial synthesis methods can either be manually performed, or can be automated. Manual synthesis requires repetitions of several relatively simple operations—addition of reagents, incubation and separation of solid and liquid phases, and removal of liquids. This character of the synthetic process renders it optimal for automation. Several designs of automated instruments for combinatorial synthesis have appeared in the patent and non-patent literature.

The combinatorial approach to the synthesis of new drug entities has stimulated the development of a wide range of technologies for parallel processing. These have ranged from simple heated agitation systems to fully automated multi-probe synthesizers. Many have been developed to meet the demand for new drug candidates, but the drive towards parallel processing in all areas of laboratory development has also expanded significantly.

Historically the discovery and optimization of candidate compounds for development as drugs has been extraordinarily expensive and time-consuming. Although the relatively new approach of “rational drug design” has promise for the future, the pharmaceutical industry has generally relied on mass screening of many-membered “libraries” of chemical compounds for the identification of “lead” compounds worthy of further study and structure-activity relationship (SAR) work. To meet this need high-throughput screening (HTS) technology has been developed that permits pharmaceutical companies to evaluate hundreds of thousands of individual chemical entities per year. Typically, these screens involve measuring some interaction (e.g., binding) between a biological target such as an enzyme or receptor and chemical compounds under test. The screens generally commence with the addition of individual compounds (or mixtures of compounds) to the individual wells in a 96 or higher-well “microtiter” plate that contains the biological target of interest (e.g., a receptor, enzyme or other protein). Ligand/receptor binding or other interaction events are then deduced by, for instance, various spectrophotometric techniques. Those chemical entities that exhibit promise in initial screens (e.g., that bind a biological target with some threshold affinity) are then subjected to chemical optimization, SAR work, other types of testing, and, if warranted, eventual development as drugs.

Now that HTS has simplified and made more cost-effective the task of determining whether large chemical libraries contain promising lead compounds or “hits”, many pharmaceutical companies are limited not by their ability to screen candidate compounds but rather by their ability to synthesize them in the first place. At one point, most pharmaceutical companies relied on their historical collections of natural products and individually synthesized chemical entities as compound libraries to be subjected to mass screening. However, expanding these libraries—especially with a view toward increasing the “diversity” of the chemical space that they probe—has proven problematic. For instance the cost of having a synthetic organic or medicinal chemist synthesizes individual molecules in a serial fashion has been estimated to be several thousand dollars, and this is obviously a painstakingly slow process.

Thus, the advent of high-throughput screening has created a need for correspondingly high-throughput chemical synthesis (HTCS) to feed this activity. “Combinatorial chemistry” and related techniques for high-throughput parallel syntheses of large chemical libraries were created in response to this need.

To simplify the separation of intermediate compounds during multistep organic syntheses, much of this chemistry is generally performed while the compound being synthesized is covalently immobilized on a solid support such as a bead. Once the chemical building blocks have been properly assembled, the desired compounds are usually cleaved from their supports (often highly swellable polymeric resins) before being carried through to HTS.

Various definitions of “combinatorial chemistry” and “combinatorial synthesis” have been proposed and are in current use. Some synthesis strategies (e.g., “split-and-mix”) are truly “combinatorial” in nature and have as their hallmark the ability to produce very large libraries; indeed, as many as a million library members can be synthesized in a modest number of reactions (and correspondingly small number of reaction vessels) by virtue of the exponential mathematics involved. One of the several limitations of such approaches, however, is the difficulty of identifying the particular individual chemical species responsible for any activity measured in an assay of what is generally a mixture of compounds.

Other approaches such as high-throughput parallel synthesis are typically used to produce somewhat smaller chemical libraries containing, for example, from several hundred to several hundred thousand individual compounds. Here, discrete compounds (and occasionally mixtures) are spatially segregated during chemical synthesis so no ambiguity exists as to the identity of any compound producing a “hit.” However, parallel synthesis requires that chemical reactions be conducted in parallel in a relatively large number of reaction vessels, thus placing a premium on the ability to automate and improve the speed and efficiency of the synthetic process.

Most high-throughput chemical syntheses (HTCS) performed in the context of combinatorial chemistry and parallel synthesis are presently conducted in multi-vessel reaction assemblies often referred to as “reaction blocks” by virtue of their monolithic construction. In most solid-phase syntheses, the compound being constructed is covalently attached to resin beads and so many of these multi-vessel reaction blocks include provision for a porous frit to retain the polymer resin beads (and compounds attached thereto) in the reaction vessel during the multiple resin washing steps that are used to remove excess reagents (e.g., building blocks, solvents, catalysts, etc.) after individual reaction steps.

Constructions based on specialized reactors connected permanently (or semipermanently) to containers for the storage of reagents are strongly limited in their throughput. The productivity of automated instruments can be dramatically improved by use of disposable reaction vessels, (such as multititer plates or test tube arrays) into which reagents are added by pipetting, or by direct delivery from storage containers. The optimal storage vehicle is a syringe-like apparatus of a material inert to the chemical reactants, etc., e.g., a glass syringe, allowing the storage of the solution without any exposure to the atmosphere, and capable of serving as a delivery mechanism at the same time. See U.S. Pat. No. 6,045,755 issued on Apr. 4, 2000.

Liquid removal from the reaction vessel (reactor) is usually accomplished by filtration through a filter-type material. The drawback of this method is the potential clogging of the filter by the solid phase support material, leading to extremely slow liquid removal, or to contamination of adjacent reactor compartments. An alternative technique based on the removal of liquid by suction from the surface above the sedimented solid phase is limited due to incomplete removal of the liquid from the reaction volume. See U.S. Pat. No. 6,045,755 issued on Apr. 4, 2000.

U.S. Pat. Nos. 5,202,418; 5,338,831; and 5,342,585 describe methods for liquid removal involving the placement of resin in polypropylene mesh packets, and removal of liquid through the openings of these packets (therefore this process is basically filtration), or removal of the liquid from the pieces of porous textile-like material by centrifugation.

Liquid removal by centrifugation was also described in U.S. Pat. No. 6,12,054 issued on Sep. 19, 2000. The method described therein generally involves the use of widely available solid phase organic synthetic protocols and disposable reaction vessel arrays such as microtiter style plates. The reaction vessel array is spun around its axis to create a “pocket” in which the solid material is retained. None of the prior art contemplates the removal of liquid by creation of “pockets” from which material cannot be removed by centrifugal force.

Microtiter plates provide convenient handling systems for processing, shipping, and storing small liquid samples. Such devices are especially useful in high throughput screening and combinatorial chemistry applications and are well suited for use with robotic automation systems, which are adapted to selectively deliver various substances into different individual wells of the microtiter plate. As such, microtiter plates have proven especially useful in various biological, pharmacological, and related processes, which analyze and/or synthesize large numbers of small liquid samples.

Standard multi-well microtiter plates come in a range of sizes, with shallow well plates having well volumes on the order of 200 to 300 microliters, with deep well plates typically having well volumes of 1.2 ml or 2.0 ml. A common example of a multi-well microtiter plate system is the standard 96-well microplate. Such microplates are typically fabricated from a variety of materials including polystyrene, polycarbonate, polypropylene, PTFE, glass, ceramics, and quartz.

Unfortunately, standard microtiter plates suffer from a number of limitations, particularly with regard to chemical synthesis. For example, spillage, leakage, evaporation loss, airborne contamination of well contents, and inter-well cross-contamination of liquid samples are some of the common deficiencies that limit the application of standard microtiter plate assemblies in high throughput synthesis systems.

Various techniques such as the inclusion of sealing layers or septums have been used in an attempt to overcome some of these shortcomings. For instance, WO 00/03805 discloses a microtiter reaction system comprising a support rack having an array of reaction wells disposed therein. The microtiter reaction system further includes a porous gas-permeable layer positioned over support rack, wherein the gas-permeable layer has an array of holes therein with each hole being positioned over each of the plurality of reaction wells. Finally, the assembly includes a gasket positioned over the porous gas-permeable layer and a top cover positioned over gasket. While effective to some degree, such microtiter assemblies are complicated, difficult to seal and reseal, and are generally expensive to manufacture.

There still remains a need for a simple, efficient means of performing solid phase synthesis, particularly a method and apparatus amenable to use with automated methods for such synthesis. There also remains a need for a simple, efficient means for preventing spillage, leakage, evaporation loss, airborne contamination of well contents, and inter-well cross-contamination of liquid samples in microtiter reaction systems suitable for use in conjunction with automated solid phase/liquid synthesis.

### SUMMARY OF THE INVENTION

The present invention allows for the integration of solid phase chemistry with the process of solution phase chemistry. Generally, the present invention provides a novel method and apparatus for solid phase, combination solution/solid phase, and solution phase reactions.

In one aspect of the invention, a reaction vessel assembly is provided which comprises a microplate having a rigid body with a plurality of open reaction wells mounted therein, a funnel cap inserted into each of the open reaction wells for at least partially sealing the open wells while allowing for venting of the well through a vent passage, and a modular solid phase immobilized within the interior volume of each of the open wells such that the modular solid phase does not block the passage of the funnel cap.

In a preferred embodiment of the invention, the funnel cap is configured so as to substantially prevent the escape of a liquid sample contained within the interior volume of the reaction wells. Further, the discrete solid phase includes a support which is preferably a rigid or self-contained polymer object comprising a rigid or self-contained, unreactive base with an active polymer attached or within containment of the unreactive base, allowing for very high exposed polymer surface area. Examples of this polymer object can be in the form of tea-bags^{[1],} crowns^{[2]}, Irori Kans^{[3]}, lanterns^{[4]}, or sintered resins^{[5]}. As long as the polymer object is rigid (not free-flowing), its support is unreactive, and it can be shaped to fit the funnel insert, it is a candidate for use within this reactor.

In another aspect of the invention, a method for performing a combination solution phase/solid phase reaction using the reaction vessel of the invention where the solid support is immobilized in the lower portion of the reaction is provided comprising the steps of:
a. Solid phase reaction wherein
   i. Reactants are added to the vessel and contacted with the solid support
   ii. A solid phase reaction occurs and the product is attached to the solid phase material
   iii. The reaction solution is removed from the vessel
   iv. A Cleaving solution is added
   v. The solid phase product is released in the solution phase
b. Solution phase as a catalyst of a solution phase reaction wherein
   i. Reactants are added to the vessel and contacted with the solid support
   ii. A solution phase reaction occurs with the solid support and the product remains in the solution phase
   iii. The solution phase product is then released in the solution phase
c. Solution phase reaction wherein the solid phase is functionalized to serve as a scavenger wherein
   i. Reactants are added to the vessel and contacted with the solid support
   ii. A solution phase reaction occurs with the solid support and the product remains in the solution phase
   iii. By products bond to the solid support
   iv. The solution phase product is recovered in the solution phase, while the by products are left behind on the solid support

In another aspect of the invention, a method for performing a combination solution phase/solid phase reaction using the reaction vessel of the invention where the solid support is immobilized in the upper portion of the reaction is provided comprising the steps of:
d. Solid Phase Reaction.
   i. Reactants are added to the vessel and initially do not contact the solid support
   ii. Reaction vessel is inverted to contact reactants with solid support
   iii. A solid phase reaction occurs with the solid support
   iv. Reaction vessel is turned upright and the reaction mixture is removed
   v. Cleavage solution is added to the vessel
   vi. Reaction vessel is inverted to contact the cleavage solution with the solid support
   vii. Solid phase product is cleaved into the solution
   viii. Reaction vessel is returned to upright position and product can be removed
e. Solution phase reaction (catalyst)
   i. Reactants are added to vessel and do not contact the solid support
   ii. Reaction vessel is inverted to contact reactants with solid support
   iii. A solution phase reaction occurs with the solid support and the product remains in the solution phase
   iv. Reaction vessel is returned to upright position.
   v. The solution phase product is then removed in the solution phase
f. Solution phase reaction (solid phase functionalized to serve as a scavenger)
   i. Reactants are added to vessel and do not contact the solid support
   ii. Reaction vessel is inverted to contact reactants with solid support
   iii. A solution phase reaction occurs with the solid support and the product remains in the solution phase
   iv. By products bond to the solid support
   v. Reaction vessel is returned to upright position
   vi. The solution phase product can now be removed in the solution phase and while the by products are left behind on the solid support

In another aspect, the invention provides a novel microtiter chemical reaction system which allows for reactions to be carried out in an inert atmosphere while minimizing spillage, leakage, evaporation, and cross-contamination.

In one embodiment of the invention, a reaction vessel assembly is provided which comprises a lower reaction well microplate assembly having a rigid body with a plurality of open reaction wells disposed therein, and a funnel cap inserted into each of the open reaction wells for at least partially sealing the open well while allowing for venting of the well through a vent passage. The reaction vessel further comprises an upper inert atmosphere cap, which is configured so as to provide a constant positive pressure of inert gas while allowing access to the lower reaction wells. In a preferred embodiment of the invention, the funnel cap is configured so as to substantially prevent the escape of a liquid sample contained within the interior volume of the reaction well. The reaction system can be used as an inert solution phase reactor where reactants are dispensed through the funnel of the upper inert atmosphere cap and through the funnel of the lower reaction vessel. The liquid reaction is contained in the lower reaction vessel while the atmosphere is controlled by the positive pressure of inert gas flowing in and out of the entire vessel through the upper cap.

In another embodiment of the invention, the inert reaction system can be used for solid phase reactions using the solid support in the lower reaction vessel. Within that vessel the solid support can be immobilized at the bottom or top of the vessel. A method for performing a combination solution phase/solid phase reaction using the reaction vessel of the invention where the solid support is immobilized in the lower portion of the reaction is provided comprising the steps of:
g. Solid phase reaction
   i. Reactants are added to vessel and contact the solid support
   ii. A solid phase reaction occurs and the product is attached to the solid phase material
   iii. The reaction solution is removed from the vessel
   iv. A Cleaving solution is added
   v. The solid phase product can now be removed in the solution phase
h. Solution phase reaction (catalyst)
   i. Reactants are added to vessel and contact the solid support
   ii. A solution phase reaction occurs with the solid support and the product remains in the solution phase
   iii. The solution phase product can now be removed in the solution phase
i. Solution phase reaction (solid phase functionalized to serve as a scavenger)
   i. Reactants are added to vessel and contact the solid support
   ii. A solution phase reaction occurs with the solid support and the product remains in the solution phase
   iii. By products bond to the solid support
   iv. The solution phase product can now be removed in the solution phase and while the by products are left behind on the solid support

In another aspect of the invention, a method for performing a combination solution phase/solid phase reaction using the reaction vessel of the invention where the solid support is immobilized in the upper portion of the reaction is provided comprising the steps of:

Inert reaction vessel, solid support is located at the upper end of the reaction vessel.
j. Solid Phase Reaction.
   i. Reactants are added to vessel and do not contact the solid support
   ii. Reaction vessel is inverted to contact reactants with solid support
   iii. A solid phase reaction occurs with the solid support
   iv. Reaction vessel is turned upright and the reaction mixture is removed
   v. Cleavage solution is added to the vessel
   vi. Reaction vessel is inverted to expose cleavage solution with solid support
   vii. Solid phase product is cleaved into the solution
   viii. Reaction vessel is returned to upright position and product can be removed
k. Solution phase reaction (catalyst)
   i. Reactants are added to vessel and do not contact the solid support
   ii. Reaction vessel is inverted to contact reactants with solid support
   iii. A solution phase reaction occurs with the solid support and the product remains in the solution phase
   iv. Reaction vessel is returned to upright position.
   v. The solution phase product can now be removed in the solution phase
l. Solution phase reaction (solid phase functionalized to serve as a scavenger)
   i. Reactants are added to vessel and do not contact the solid support
   ii. Reaction vessel is inverted to contact reactants with solid support
   iii. A solution phase reaction occurs with the solid support and the product remains in the solution phase
   iv. By products bond to the solid support
   v. Reaction vessel is returned to upright position

The solution phase product can now be removed in the solution phase while the by products are left behind on the solid support.

In another embodiment of the invention, the polymer object can also be shaped to fit into the reaction vessel in such a way that it does not interfere with the action of aspirating or dispensing from this vessel. The polymer object would take the shape of a cylinder or donut and reside on the outer wall of the reaction vessel. The funnel cap can be used to ensure that the accessing device does not contact the polymer object.

In another embodiment of the invention, the polymer can be directly attached to the walls of the reaction vessel, perhaps through sintering^{[5]}, whereas the solid support would be the reaction vessel itself. The polymer object would reside on the perimeter of the reaction vessel to avoid interference with the accessing device. Again, the funnel cap could be used to ensure that the accessing device does not contact the polymer object.

In yet another embodiment the inert reaction system can utilize the shaped polymer placed into the lower reaction vessels or the polymer can be attached to the walls of the lower reaction vessel.

### BRIEF DESCRIPTION OF THE DRAWINGS

FIG. 1 illustrates details of a preferred spill proof microplate assembly for use with the reaction vessel of the present invention.

FIG. 2 shows an embodiment of an individual reaction vessel well of the present invention with the solid phase support immobilized near the bottom of the reaction well.

FIG. 3 shows an individual reaction vessel well of the present invention with an injection needle inserted through a vent passageway.

FIG. 4 shows the individual reaction vessel well of FIG. 3 with the injection needle removed.

FIG. 5 shows another embodiment of an individual reaction vessel well of the present invention with the solid phase support immobilized near the top of the reaction well.

FIG. 6 shows the individual reaction vessel well of FIG. 5 in an inverted position.

FIG. 7 illustrates details of one embodiment of the inert microtiter chemical reaction system of the present invention.

FIG. 8 illustrates the inert microtiter chemical reaction system of the present invention with the solid phase inserts at the bottom of the funnels in the lower vessel.

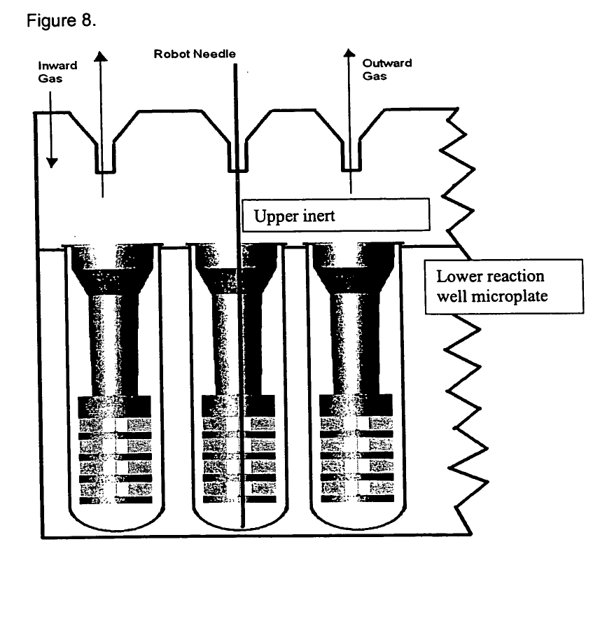

FIG. 9 illustrates the inert microtiter chemical reaction system of the present invention with the solid phase inserts at the top of the funnels in the lower vessel.

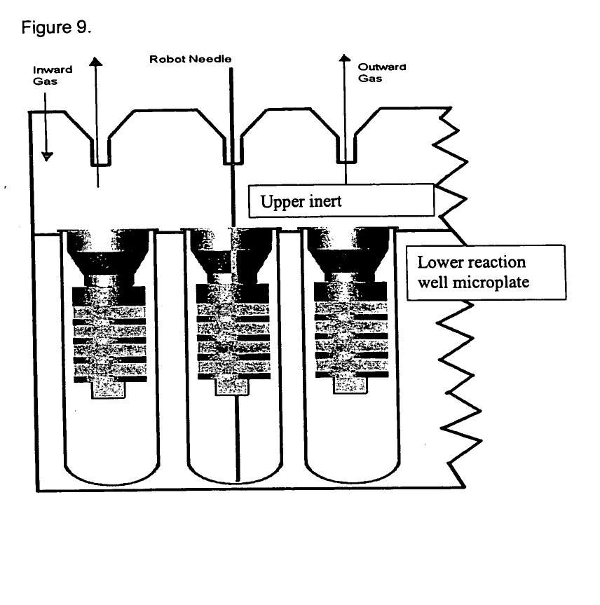

FIG. 10 illustrate the inert microtiter chemical reaction system of the present invention with the solid phase material sintered or press fit into the lower vessel.

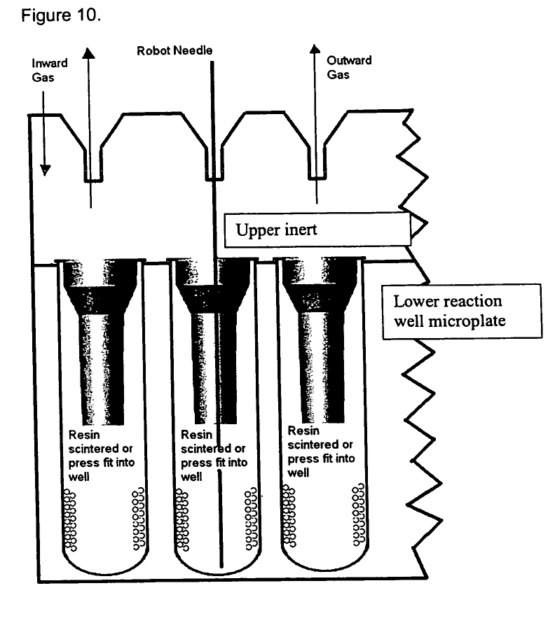

FIG. 11 illustrate a reaction vessel with no insert and solid support fused or press fit into a reaction vessel.

### DETAILED DESCRIPTION OF THE INVENTION

By way of introduction, in solid phase synthesis, final compounds are synthesized attached to solid-phase supports that permit the use of simple mechanical means to separate intermediate or partially synthesized intermediate compounds between synthetic steps. Conventional solid-phase supports generally include beads, including microbeads, of 30 microns to 300 microns in diameter, which are functionalized in order to covalently attach intermediate or final compounds, and are made of, e.g., various glasses, plastics, or resins.

Solid-phase combinatorial synthesis typically proceeds according to the following steps. In a first step, reaction vessels are charged with a solid-phase support, typically a slurry of functionalized beads suspended in a solvent. These beads are then preconditioned by incubating them in an appropriate solvent, and the first of a plurality of building blocks, or a linker moiety, is covalently linked to the functionalized beads. Subsequently, a sequence of reaction steps is performed in a sequence chosen to synthesize the desired compound in a manner as follows.

First, a sufficient quantity of a solution containing the building block moiety selected for addition is accurately added to the reaction vessels so that the building block moiety is present in a molar excess to the intermediate compound. The reaction is triggered and promoted by activating reagents and other reagents and solvents, which are also added to the reaction vessel. The reaction vessel is then incubated at a controlled temperature for a time, typically between 5 minutes and 24 hours, sufficient for the building block addition reaction or transformation to go to substantial completion. Optionally, during this incubation, the reaction vessel can be intermittently agitated or stirred. Finally, in a last substep of building block addition, the reaction vessel containing the solid phase support with attached intermediate compound is prepared for addition of the next building block by removing the reaction fluid and thorough washing and reconditioning the solid-phase support. Washing typically involves three to seven cycles of adding and removing a wash solvent.

Optionally, during the addition steps, multiple building blocks can be added to one reaction vessel in order to synthesize a mixture of compound intermediates attached to one solid-phase support, or alternatively, the contents of separate reaction vessels can be combined and partitioned in order that multiple compounds can be synthesized in one reaction vessel with each microbead having only one attached final compound. After the desired number of building block addition steps, the final compound is present in the reaction vessel attached to the solid-phase support. The final compounds can be utilized either directly attached to the synthetic supports, or alternatively, can be cleaved from the supports and extracted into a liquid phase.

With this process in mind, the present invention generally provides a novel, automation-compatible solid phase reaction vessel, as well as methods for using such a vessel. Generally, the reaction vessel comprises a microplate assembly with a modular solid phase support included within the individual reaction wells. The reaction vessel of the invention allows for the integration of solid phase chemistry with the processing abilities of solution phase chemistry. Thereby providing more flexibility in the synthesis steps that can be carried out and therefore significantly increasing the ability to probe complex synthesis mechanisms.

According to the invention, the microplate assembly and the solid phase supports are configured so as to integrate together into a single reaction vessel. The combination enables solid phase reactions in a single vessel with full compatibility to liquid handling automation.

Microplate Assembly

The present invention can employ any microplate assembly known in the art. For instance, a standard microplate assembly can comprises a microplate having a plurality of open wells and a closure device for sealing the wells shut. Commonly available microplates generally embody a unitary molded structure comprising a rigid frame for housing a plurality of open wells arranged in a rectangular array. Standard well closures include resilient, press-fit stoppers, rigid screw caps, adhesive films, and the like. Microplates come in a range of sizes; a well may be sized to hold as high as five milliliters or as low as only a few microliters of liquid or even sub-micro quantities of liquid (e.g. in the range of few nanoliters). In addition, microplates come in a variety of materials, such as polystyrene, polycarbonate, polypropylene, Teflon, glass, ceramics, and quartz. Microplates found in many high-throughput systems comprise a 96-well geometry molded into an 8×12 rectangular array of open wells. Microplates with lower well densities (e.g., 24 and 48 wells) and higher well densities (e.g., 384 and 864 wells) are also available.

More preferably however, the microplate assembly of the present invention is a spill proof microplate assembly having a plurality of open wells, such as those disclosed in U.S. Pat. No. 6,027,694, which is incorporated herein by reference. Each of the wells comprises a vessel with an interior volume. A seal is coupled to the wells for sealing the wells so that liquid in the interior volume is prevented from exiting the wells. A vent equalizes the pressure of the wells with the ambient pressure.

The structure and function of the preferred embodiments of the invention can best be understood by reference to the drawings. It will be noted that the same reference numerals appear in multiple figures. Where this is the case, the numerals refer to the same or corresponding structure in the figures. It should further be noted that many of the general functions and operations described below in connection with particular embodiments of the apparatus of the present invention may be realized equally well by a number of alternative mechanical designs that will suggest themselves to those of skill in the art. Such functionally equivalent alternatives, similar in concept but different in mechanical detail, are within the scope of the present invention.

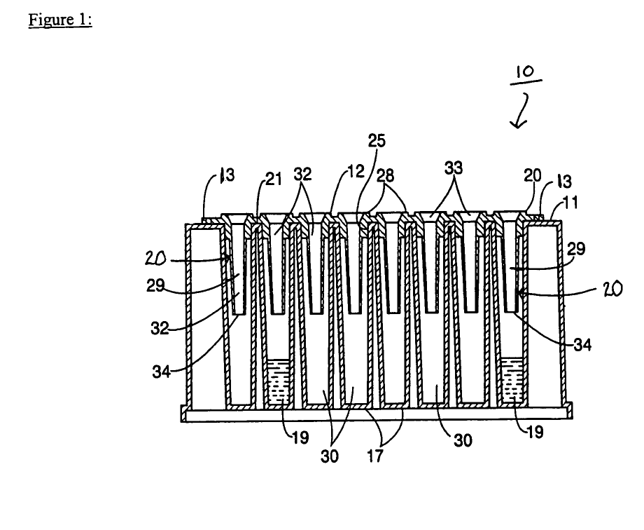

In one embodiment of the invention, the spill proof microplate assembly 10 comprises a multi-well microplate 11, a plurality of funnel caps 12 and an optional porous vent film 13 (see FIG. 1). The microplate 11 houses a plurality of open wells 17 in a rectangular array. The funnel caps 12 seal and vent the wells 17. When the funnel caps 12 are coupled to the wells, an interior volume 30 is formed in each well 17. The wells are thus configured to accommodate liquid samples 19 within predetermined spaces of the interior volumes 30. The liquid samples 19 remain within the predetermined space for all orientations of the microplate assembly.

In one embodiment, the funnel caps 12 comprise sealing plugs 28 and vent tubes 29, which can optionally be interconnected by a porous perforated web 13. The sealing plugs 28 form a seal at the mouth of the open wells 17. The vent tubes 29 attach to the sealing plugs 28 and terminate in vents 34. The vents 34 communicate with the interior volumes 30 outside the predetermined spaces, which can accommodate liquid samples 19. The vents 34 permit the pressure within the interior volume 30 to be equalized with the ambient pressure via a passage that runs through the vent tube 29 and the sealing plugs 28. Material may be added to or removed from the wells 17 via the passages 34. The optional perforated web 13 can have an adhesive coating which adheres the web to the funnel caps 12 while covering the passages 34, thereby inhibiting evaporation of tile liquid samples.

Consequently, vent caps 12 function as multiple vented seals for interior volumes 30 of wells 17. Each well insert 20 couples with a different well 17 such that plug 28 forms a tight press-fit seal with the edge of the mouth of the well 17. With vent cap 12 properly coupled to wells 17, each plug 28 prevents liquid sample 19 from exiting the interior volume 30 via the seam at the interface between plug 28 and tile mouth of the well 17. In addition, each vent 34 will permit the pressure within interior volume 30 to be equalized with tile ambient pressure via passage 32, thereby avoiding forces that may dislodge plug 28.

As mentioned above, manufactures typically fabricate microplates from polystyrene, polycarbonate, polypropylene, Teflon, glass, ceramics, or quartz. As such, vent caps 12 may be readily molded from a variety of compatible materials. In this regard, the materials of funnel cap 12 must be such that plugs 28 will have sufficient resiliency to form a good press-fit seal with the mouth of well 17. In addition, optional web 13 preferably can flex to allow for easy positioning and removal of vent cap 12.

Further, the microplate assembly of the invention can be configured as a microfilter plate such that liquid reagent samples can be removed through the filter upon the application of suction, as is known in the art.

Solid Phase Supports

The solid phase support of the present invention may include any of the many different known types of solid phase supports and is not limited by the nature of any functional group(s) linked to the support. The only requirements are that the solid phase support should include a discrete, modular structure, and should be substantially insoluble in aqueous and organic solvents. Further, the solid phase support should be substantially inert to the reaction conditions needed to employ the solid support in chemical synthesis; any modular, immobilizable solid phase support known in the art can be used.

For instance, organic polymer resins, silica based compounds, and composites are within the scope of the invention so long as they arc incorporated into a modular base which can be inserted and immobilized within the individual wells of the microplate assembly. By employing such solid phase supports with a modular base, solid phase synthesis techniques can be carried out without the filtration, weighing, handling, and cleavage problems generally associated with conventional resin techniques.

Generally, solid phase supports include various linkers. Linkers are solid-phase protecting groups, which allow attachment of a scaffold or template molecule to a solid phase; support. Attachment of the scaffold or template undergoing chemical modifications to a solid phase support provides a practical method for removal of excess reagents and starting materials via extensive washing and filtration without loss of product. After suitable chemical modifications, the scaffold or template can be cleaved from the solid phase support under selective conditions that will not alter the modified scaffold or template.

Linkers are molecules that are attached to a solid support and to which the desired members of a library of chemical compounds may in turn be attached. When the construction of the library is complete, the linker allows clean separation of the target compounds from the solid support without harm to the compounds and preferably without damage to the support. Several linkers have been described in the literature. Their value is constrained by the need to have sufficient stability, which allows the steps of combinatorial synthesis under conditions that will not cleave the linker. An additional constraint is the need to have a fairly high liability under at least one set of conditions that is not employed in the chemical synthesis.

For example, if an acid labile linker is employed, then the combinatorial synthesis must be restricted to reactions that do not require the presence of an acid of sufficient strength to endanger the integrity of the linker. Likewise, when a photocleavable linker is employed, conditions that exclude light are necessary to avoid untimely cleavage of the compound from the resin. This sort of balancing act often imposes serious constraints on the reactions that are chosen for preparation of the library.

For example, 4-[4-(hydroxymethyl)-3-methoxyphenoxy] butyryl residue is a known linker, which is attached to a solid support having amino groups by forming an amide with the carboxyl of the butyric acid chain. N-Protected amino acids are attached to the hydroxyl of the 4-hydroxymethyl group via their carboxyl to form 2,4-dialkoxybenzyl esters, which can be readily cleaved in acid media when the synthesis is complete. The drawback to such 2,4-dialkoxybenzyl esters is their instability with many of the reagents that are available for use in combinatorial synthesis resulting in cleavage of the ester.

A somewhat more stable ester is formed from 4-[4-(hydroxymethyl) phenoxy] butyric acid, described in European published application EP 445915. In this case, the ester was cleaved with a 90:5:5 mixture of trifluoroacetic acid, dimethyl sulfide and thioanisole. When the desired product is a peptide amide, the 4-[4-(formyl)-3,5-dimethoxyphenoxy] butyryl residue has been employed as a linker. This particular linker is attached to a solid phase substrate via the carboxyl of the butyric acid chain, and the 4-formyl group is reductively aminated. N-Protected amino acids are then reacted with the alkylamine via their carboxyl to form 2,4,6-trialkoxybenzylamides. These may be cleaved by 1:1 trifluoroacetic acid in dichloromethane (PCT application WO97/23508).

If a photocleavable linker is used to attach chemical compounds to the main support, milder photolytic conditions of cleavage can be used which complement traditional acidic or basic cleavage techniques. A wider range of combinatorial synthetic conditions will be tolerated by photocleavable linkers.

Other examples of linkers include a phenacyl based linking group that is photocleavable. The 4-bromomethyl-3-nitrobenzoyl residue has been widely employed as a photocleavable linker for both peptide acids and amides.

Photocleavable linkers such as the 3-bromomethyl-4-nitro-6-methoxyphenoxyacetyl residue are stable to acidic or basic conditions yet, are rapidly cleavable under mild conditions and do not generate highly reactive byproducts (U.S. Pat. No. 5,739,386, issued Apr. 14, 1998).

More particularly, in a preferred embodiment, the solid phase support includes polyethylene, polypropylene, polytetrafluoroethylene supports. Generally these supports are comprised of a mobile polymer, such as polystyrene, polyacrylamide or polyacrylic acid, attached onto a rigid unreactive base polymer core. The active surface polymer can optionally have functional groups attached along the backbone, including amines, alcohols, and other linkers.

The modular base polymer core can be shaped to maximize surface area while allowing efficient drainage of liquid when the reaction mixture is removed. In a particularly preferred embodiment, the solid phase support is cylindrical in appearance for compatibility with microplate assembly well dimensions.

As mentioned above, the solid phase supports of the invention can optionally be functionalized with one or more functional groups. That is, the supports can have one or more functional groups usually covalently linked thereto. The functional groups may be incorporated into the active surface polymer, or may be covalently attached to the surface of the polymer. The functional groups can provide a reactive site for attachment of an optional spacer group or linker. Several solid phase particles having functional groups covalently linked thereto have been described in the chemical and biochemical literature. For example, see E. Atherton and R. C. Sheppard, “Solid Phase Synthesis: A Practical Approach” Oxford University Press, 1989, and E. C. Blossey, “Solid Phase Synthesis,” Dowden Hutchinson & Ross Publishers.

The solid phase support of the invention can also include an optional spacer group. The spacer group can serve to provide the connection between the solid support and a linker. The spacer can function to tether the linker away from the solid phase support, thereby minimizing the effect of the neighboring solid phase support on the chemical reactivity of the linker. The spacer group may consist of a chain of atoms between (to 1,000 atoms in total. In some instances, it is desirable for no spacer group to be employed. When employed, the spacer group typically consists of an alkyl, cycloalkyl, or aryl grouping of atoms. Tills grouping may contain branching and or may contain heteroatoms. The spacer group may also consist of a combination of alkyl, cycloalkyl, and aryl.

As mentioned above, the solid phase supports of the invention can be provided with a derivatized surface and/or linkers, as is known in the art. For instance, the surface can be aminomethylated, chloromethylated, or hydroxymethylated. Further, the surface can include a rink amide linker, a hydroxymethylphenoxy linker, a trityl alcohol linker, a hyperliabile linker, or a backbone amide linker.

The solid phase supports useful in the present invention should be substantially insoluble in both organic and aqueous solvents. Selection of organic solvent is described below. Generally, less than 20% of 1 g of the support should solubilize in 1000 g of an aqueous or organic solvent at 40° C. and atmospheric pressure. More typically, less than 15% of 1 g of the support will solubilize in 1000 g of aqueous or organic solvent at 40° C. and atmospheric pressure. Preferably, less than 10% of 1 g of the support will solubilize in 1000 g of aqueous or organic solvent at 40° C. and atmospheric pressure.

An important aspect of the present invention is that the solid support is substantially insoluble in the organic solvents with which it will be used. Organic solvents suitable for the present invention include, but are not limited to the ones listed in Table 1 below:

TABLE 1
Examples Of Organic Solvents For Use With Solid Phase Supports

| | |
|---|---|
| Alcohols: | Methanol, ethanol, isopropanol, n-propanol, n- |
| | butanol, iso-butanol, amyl alcohol, |
| | hexafluoroisopropyl alcohol, benzyl alcohol, |
| | phenol, diethylcne glycol, propylene glycol |
| Ketones | Acetone, methyl ethyl ketone, methyl isopropyl |
| | ketone, methyl isobutyl ketone, cyclohexanone |
| Halocarbons | Dichloromethane, chloroform, trichloroethylene, |
| | tetrachloroethylene, [1,1,1]-trichloroethane, |
| | trichlorotrifluorethane, carbon tetrachloride), |
| | hydrocarbons |
| | (pentane, hexane, heptane, octane) |
| Aromatic | Benzene, toluene, xylene, m-cresol, |
| hydrocarbons | chlorobenzene, trifluoromethyl benzene), amides |
| | (dimethyl formamide, dimethyl acetamide, N- |
| | methylpyrrolidinone), sulfoxides/sulfones |
| | (dimethyl sulfoxides, dimethyl sulfone, sullblanc) |
| Nitriles | Acetonitrile, ethyl nitrile ethers (tetrahydrofuran, |
| | diethyl ether, |
| | [1,4]-dioxane) |
| Organic acids | Acetic acid, formic acid |
| Amines | Pyridine, aniline, triethanolamine |
| Esters | Butyl acetate, ethyl acetate, trimethyl phosphate |
| Nitro | Nitromethane, nitrobenzene |
| compounds | |

Reaction Vessel

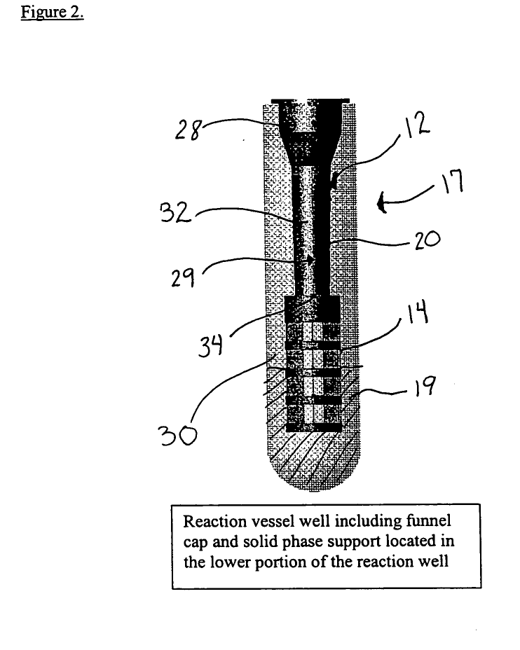

Referring back to the drawings, in a particularly preferred embodiment of the invention, microplate assembly 10 comprises microplate 11 and funnel caps 12. Microplate 11 includes an array of wells 17. FIGS. 2-5 depict an individual well 17 of the invention, which functions as a receptacle for the solid phase support 14 and any liquid reagent samples 19. The wells 17 of the invention can be shaped like a conventional test tube. However, as will become apparent from the following description, the present invention is applicable to a variety of conventional microplate configurations and well shapes.

With reference to FIG. 2, funnel caps 12 each comprise a well insert 20 optionally interconnected by perforated web (not shown). Each well insert 20 includes sealing plug 28 with attached vent tube 29. Passage 32 extends through vent tube 29 and sealing plug 28. Passage 32 terminates in vent 34 at its lower end. Vent tube 29, sealing plug 28 and the interior walls of well 17 form interior volume 30 in which solid phase support 14 is immobilized, and liquid reagent sample 19 can be deposited. The solid phase support 14 can be immobilized anywhere within interior volume 30.

For instance, as shown in FIG. 2, the solid phase support 14 can be shaped as a hollowed cylinder, and can be immobilized at the base of vent tube 29 such that the interior passage of the solid phase support 14 is coincident with passage 32 to thereby result in a continuous vent passage which extends the length of the vent tube 29 and the solid phase support 14. Liquid reagent sample 19 can then occupy and remain confined to a liquid-holding space within interior volume 30 for all orientations of well 17 until removed by aspiration, filtration or other removal method known in the art.

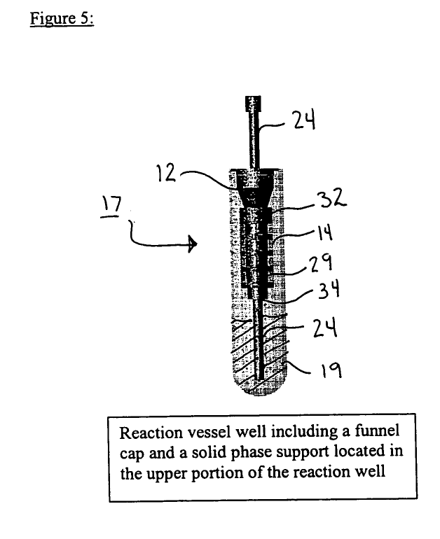

Alternatively, as shown in FIG. 5, the solid phase support 14 can be immobilized within the upper portion of the interior volume 30 of the well 17. Again, in one embodiment, the solid phase support can be configured as a hollow cylinder, which can be positioned about the exterior circumference of the funnel cap well insert 20. Such a reaction vessel configuration is particularly suited for combination solution phase/solid phase reaction methodologies as described below.

Manufacturers may readily choose appropriate dimensions for vent caps 12 so that the solid phase support 14 can be in contact with liquid reagent sample 19. Further, sealing plug 28 and its associated vent tube 29 can be shaped so as to prevent loss of liquid reagent sample 19. For instance, the shape and size of vent 34 and passage 32 can be such that it is difficult for liquid to exit passage 32 due to fluid surface tension. Therefore, during all but the most violent movements of microplate assembly 10, liquid reagent sample 19 can remain in its liquid-holding space.

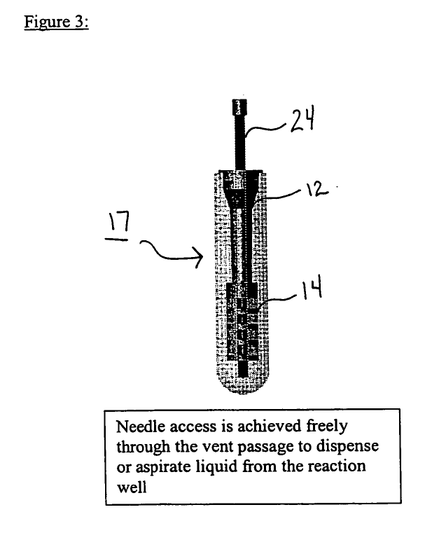

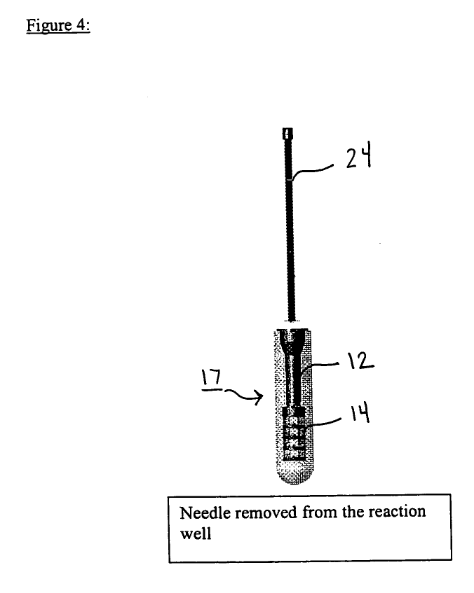

Microplate assembly 10 includes features that make it suitable for use in a variety of processes. Passage 32 permit the addition and removal of material to and from the interior volume 30 without requiring that vent caps 12 be removed, altered or otherwise manipulated. As shown in FIGS. 3 and 4, such materials may be added to or removed from wells 17 as a liquid, a gas, or a solid. In the later case, of course, the solid must be dimensioned to permit movement through passage 32. As illustrated in FIGS. 34, liquids may be injected into or removed from wells 17 with the aid of injection probe 24. Likewise, solids, e.g., pellets or a powder, may also be deposited or removed via passages 32. Gases may also be directed into wells 17 via passages 32 using probes or other gas injection apparatus to provide, for example, a special environment in volume 30.

Microplate assembly 10 can be used in either manual or automatic processes. For instance, passages 32 provide a convenient avenue through which material may be inserted manually into wells 17, with or without the use of a probe or other apparatus. In this regard, passages 32 may act as funnels to help lead the material into interior volume 30. On the other hand, most automation processes use one or more probes or needles 24 to add material or remove material via suction. In this instance, fluted apertures can aid the automation process by acting as self-centering guides that can easily direct probe 24 into passages 32. A splined probe or one that is narrower than vent 34 will allow venting to occur during liquid injection or aspiration. Alternatively, vents 34 may be fabricated with polygonal cross-sections to prevent round probes from inhibiting venting of interior volume 30.

Novel Microtiter

While the subject invention can be practiced with any suitable automation-compatible reaction vessel, one preferred embodiment employs a novel inert microtiter according to one aspect of the subject invention.

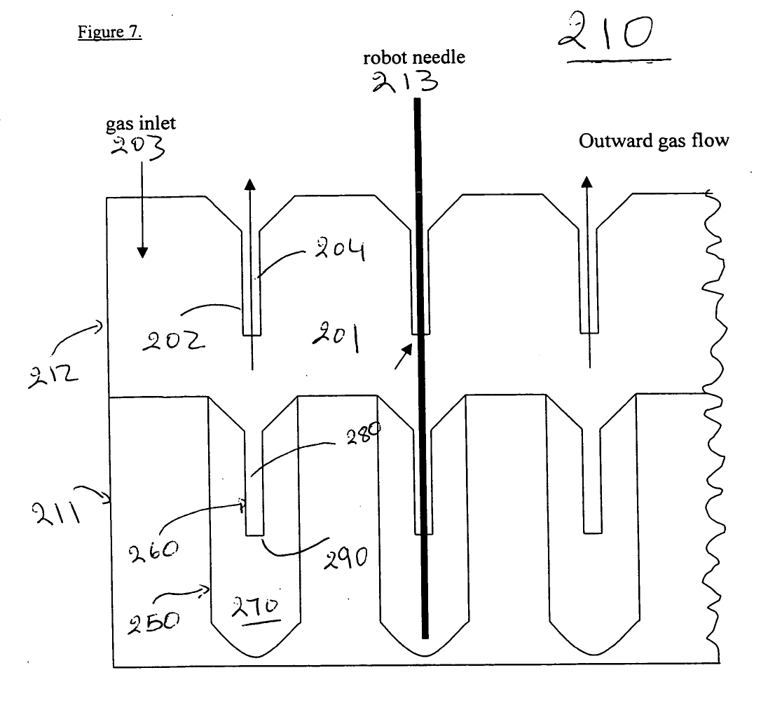

As indicated above, one aspect of the invention provides a novel, automation-compatible inert chemical reaction vessel, as well as methods for using such a vessel. Generally, as shown in FIG. 7, the reaction vessel 210 according to this aspect of the invention comprises a lower reaction well microplate assembly 211 and an upper inert atmosphere cap 212. The reaction vessel 210 is configured so as to achieve an inert atmosphere by constantly flushing the upper inert atmosphere cap 212 with an outward flow of inert gas while providing for access to the lower reaction well microplate assembly 211. More particularly, the lower reaction well microplate assembly 211 provides individual reaction well volumes 250 while the upper inert atmosphere cap 212 maintains a common gas volume 201.

Lower Reaction Well Microplate Assembly

The present invention can employ any microplate assembly known in the art as the lower reaction well microplate assembly 211. For instance, a standard microplate assembly can comprises a microplate having a rigid body with a plurality of open wells. Commonly available microplates generally embody a unitary molded structure comprising a rigid frame for housing a plurality of open wells arranged in a rectangular array. Microplates come in a range of sizes; a well may be sized to hold as high as five milliliters or as low as only a few microliters of liquid. In addition, microplates come in a variety of materials, such as polystyrene, polycarbonate, polypropylene, Teflon, glass, ceramics, and quartz. Microplates found in many high-throughput systems comprise a 96-well geometry molded into an 8×12 rectangular array of open wells. Microplates with lower well densities (e.g., 24 and 48 wells) and higher well densities (e.g., 384 and 864 wells) are also available.

In one embodiment, the microplate assembly of the present invention is a spill proof microplate assembly having a plurality of open wells similar to that disclosed in U.S. Pat. No. 6,027,694, which is herein, incorporated by reference. Each of the wells comprises a vessel with an interior volume.

In a preferred embodiment, the lower reaction well microplate assembly 211 comprises a multi-well microplate with an array of individual reaction wells 250, and a plurality of registered funnel vents 260. When the funnel vents 260 are coupled to the individual reaction wells 250, an interior volume 270 is formed in each well 250. The wells are thus configured to accommodate liquid samples within predetermined spaces of the interior volumes 270. The funnel caps 260 are configured such that liquid samples remain within the predetermined space for all orientations of the microplate assembly 211. See U.S. Pat. No. 6,027,694 for further detail on the spill-proof design of funnels vents 260.

In one embodiment, the funnel vents 260 comprise vent tubes 280, which can optionally be interconnected by a porous perforated web (not shown). The vent tubes 280 terminate in vents 290, which communicate with the interior volumes 270 outside the predetermined spaces which, can accommodate liquid samples. The vents 290 permit the pressure within the interior volume 270 to be equalized with the pressure of the common gas volume of the upper inert atmosphere cap 212 via a passage that runs through the vent tube 280. Material may be added to or removed from the wells 250 via the passage through vent tube 280. The optional perforated web 213 can have an adhesive coating which adheres the web to the funnel vents 260 while covering the passages of vent tubes 280, thereby further inhibiting evaporation of the liquid samples.

Further, the microplate assembly of the invention can be configured as a microfilter plate such that liquid reagent samples can be removed through the filter upon the application of suction, as is known in the art.

Upper Inert Atmosphere Cap

The upper inert atmosphere cap 212 of the invention generally is configured so as to provide a common gas volume 201 above lower reaction well microplate assembly 211 while allowing for access to individual reaction wells 250. In one embodiment, the upper inert atmosphere cap 212 comprises at least one inert gas inlet 203 in communication with common gas volume 201, and a plurality of inert gas outlets 202 in registration with the plurality of funnel caps 260.

The inert gas outlets 202 allow for an outward flow of inert gas through outlet vent tube 280 to provide a positive pressure of inert gas in common gas volume 201. Further, when inert gas outlets 202 are in registration with funnel vents 260, an access passageway is provided through outlets 202 and vents 260 into interior volumes 270 of reaction wells 250. The upper inert atmosphere cap 212 is thus configured so as to provide a constant positive pressure of inert gas while allow for access to the lower reaction wells. For instance, in an automated setting, robot needle 213 can access interior volume 270 through inert gas outlets 202 and funnel vents 202.

In another aspect of the invention, a method for achieving an inert atmosphere in reaction vessel of the invention is provided. Such a method generally comprises providing an inert gas flow through inert gas inlet 203 such that an outward gas glow of at least about 5 mm/sec through inert gas outlets 202 is achieved. By way of example, when the lower reaction well microplate assembly is configured as a 96-well plate with funnel vents and inert gas outlets having a 2 mm aperture, 6 liters of inert gas per hour is required to maintain a 5 mm/sec outward gas flow. Such a gas flow is able to maintain an inert atmosphere within reaction wells 250 for at least 24 hours.

Solid Phase Adhered to the Interior Walls of the Reaction Wells

One aspect of the subject invention provides a general reactor design, which affords many of the advantages inherent in solid phase synthesis, such as ease of purification, and simple work-up, without the difficulties associated with the transfer of solid support materials or devices. The reactor takes well-defined structural materials common in reactor design such as but not limited to polypropylene, glass, or Teflon, and incorporates a support material for chemical synthesis. These support materials can include but are not limited to many of the common supports used in solid phase synthesis, such as polystyrene based supports like Wang resin, Merrifield resin, Rink resin, REM resin etc, as well as other less commonly used supports such as PEGylated resins, CLEAR resin and other custom designed supports.

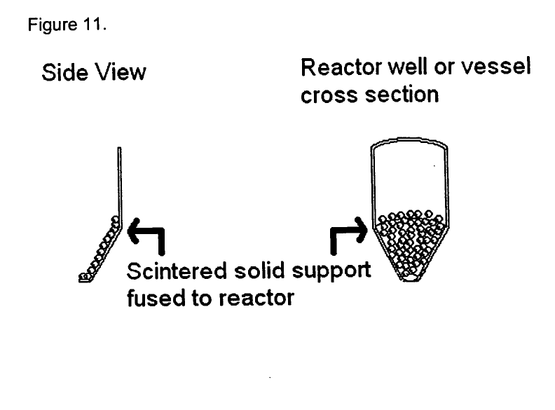

As illustrated in FIG. 11 the reactor and the resin are fused or bound into a single unit. The binding process occurs only at the interior surface of the reactor and provides an interior surface that has very high surface area and incorporates the desired functionalized support material. An added advantage to this type of binding process is much more stringent control over the physical characteristics of the synthesis resin. For example, swelling upon exposure to various solvents (as well as shrinkage) can be controlled due to the presence of the support material. This entire process leaves the exterior surface of the reactor intact, thus ensuring that structural integrity of the reactor remains uncompromised.

The new reactor design has many additional advantages. The simplicity of the formation of the reactor allows for mass production in microtiter plate or similar format, thus providing lower cost. It allows for de novo synthesis of compounds in discrete reactors, utilizing the ‘Cherry Picking’ strategy without the need to manually transfer the solid support material or device. The binding methodology can be scaled according to reactor design and size. Therefore, the reactor or reactors can exist as individual reactors for larger scale work or as an array for discovery type work depending on the scale and the application. Thus, simply by using a larger reactor one can use the same chemistry methodology for initial discovery and scale-up.

Examples and Reaction Methodologies

The reaction vessel of the invention can be used to perform solid phase synthesis with solution phase liquid handling automation generally by guiding the tips of injection probes and needles through the funnel cap and into the interior volume of the individual wells of the reaction vessel. The solid phase support can be positioned on the funnel cap so as not to interfere with the automation. Reagents can be added to the wells of the reaction vessel as if performing a solution phase reaction, but reactions take place on the solid phase support. Reaction solutions can then be removed and wash solutions can be added using standard liquid handling automation without the drawbacks associated with traditional resin based solid phase supports.

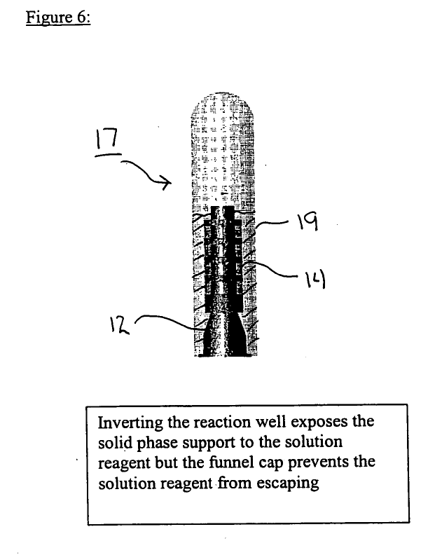

In another embodiment of the invention solid phase reaction steps can be combined with solution phase reaction steps. For example, the solid phase support can be used in only certain reaction steps, while allowing other reaction steps to proceed in the solution phase. More particularly, as shown in FIGS. 5-6, the solid phase support can be placed near the top of the vent tube of the funnel cap. In such an embodiment, an intermediate (or final) reaction product can be formed by solution-phase synthesis with the reaction vessel in an upright position (FIG. 5). The reaction vessel can then be inverted so that the solution phase reaction mixture is contacted with the solid phase support located in the upper portion of the interior volume of the reaction well (FIG. 6). The intermediate (or final) reaction products contained in the solution phase can then be reacted on the solid phase support. In this manner, the solid phase support can serve, e.g., as a capture step, a catalyst, or can contain a scaffold template molecule with which the solution phase intermediate reaction product is reacted to forth a final reaction product bound to the solid phase support.

Alternatively, a solid phase reaction can be performed in a first step, the solid phase reaction product can be cleaved from the solid phase support, the reaction vessel can be inverted, and a solution phase reaction can be performed with the cleaved solid phase reaction product as a starting material. By way of example, such a combination reaction methodology can be used with covalent scavenger technology, to immobilize solid phase catalyst for use in only certain reaction steps, or as a capture step to remove unreacted reagents or reaction products.

The combined liquid/solid phase capability in a high through put synthesis context as provided by the present invention is greatly advantageous in that more complex synthesis mechanisms can now be explored thereby allowing more versatility in the synthesis of novel molecules. The present invention is also advantageous in that it provides a tool for synthesizing novel molecules with increased speed. The advantages of the present invention are particularly beneficial in the context of the rational design of new molecules de novo where feasible and economical synthesis pathways are not readily available. It is expected that the present invention will reduce the bottleneck impediments associated with present combinatorial chemistry synthesis methods.

Of course, various other modifications and variations are contemplated and may obviously be resorted to in light of the present disclosure. It is to be understood, therefore, that within the scope of the appended claims, the invention may be practiced otherwise than as specifically described.

### References

[1] R. A. Houghten, Proc. Natl. Acad. Sci 1985, 82, 5131
[2]
   a) R. M. Valerio, A. M. Bray, N. J. Maegi, Int. J. Pept. Protein Res. 1994, 44, 158; b) A. M. Bray, D. S. Chiefari, R. M. Valerio, N. J. Maeji.
      Tetrahedron Lett. 1995, 36, 5081; c) R. M. Valerio, A. M. Bray, H.
      Patsiouras, Tetrahendron Lett, 1996, 37, 3019; d) A. A. Virgilio, J. A.
      Ellman, J. Am Chem. Soc. 1994, 116, 11580; e) B. A. Bunin, M. J.
      Plunkett, J. A. Ellman, New J. Chem. 1997, 21, 125; f) A. A. Virgilio,
      A. A. Bray, W. Zhang, L. Trinh, M. Snyder, M. M. Morrissey, J. A.
      Ellman, Tretrahedron 1997, 53, 6635; g) B. A. Bunin, M. J. Blunkett
      Proc. Natl. Acad. Sci. USA 1994, 91, 4708; j) B. A. Bunin, J. A.
      Ellman, J.Am. Chem. Soc. 1992, 114, 10997.
[3]
   a) K. C. Nicolaou, N. Winssinger, D. Vourloumis, T. Ohshima, S. Kim,
      J. Pfefferkorn, J.-Y. Xu, T. Li, J. Am. Chem. Soc. 1998, 120, 10814; b) S.
      Shi, X.-Y. Xiao, A. W. Czarnik, Biotechnol. Bioeng. 1998, 61, 7; c) C. J.
      Anres, R. T. Swann, K. Grant-Young. S. V. D″Andrea, M. S.
      Desh-pande, Comob. Chem. High Throughput Screening 1999, 2, 29; d) K. C.
      Nicolaou, X.-Y. Xiao, Z. parandoosh, A. Senyei, M. P. Nova, Angew.
      Chem. 1995, 107, 2476; Andgew. Chem. Int. Ed. Engl. 1995, 34, 2289.
[4] Rasoul F, Ercole F, Pham Y, Bui C T, Wu Z, James S N, Trainor R W, Wickham G, Maeji N J. Biopolymers 2000; 55(3): 207-16, Grafted supports in solid-phase synthesis.
Mimotopes Pty Ltd., 11 Duerdin Street, Clayton, Victoria, 3168, Australia.
[5] Patent application GB99/03406 Porvair Sciences Ltd.

1. A reaction vessel assembly comprising:
a microplate having a rigid body with a plurality of open reaction wells disposed therein, each of said open reaction wells comprising a fluid vessel with an opening and an interior volume with a sample-holding space located therein;
a funnel cap inserted into each of the open reaction wells for at least partially sealing the open well while allowing for venting of the well through a vent passage;
a modular solid phase disposed within the interior volume of each of the open wells such that the modular solid phase does not block the passage of the funnel cap; whereby the reaction vessel is accessible through the funnel cap at all times.

2. The reaction vessel of claim 1, wherein the solid phase is an exposed polymer surface object comprising a rigid or polymer-containing, unreactive base, wherein the polymer is attached or contained by the base.

3. The reaction vessel of claim 2, wherein the active polymer attached to the unreactive base is selected from the group consisting of polyethylene, polypropylene, and polytetrafluoroethylene.

4. The reaction vessel of claim 1, wherein each funnel cap comprises a sealing plug and a vent tube;
wherein the sealing plug forms a seal at the mouth of the open wells; and
the vent tube forms the vent passage, attaches to the sealing plug and terminates in a vent opening.

5. The reaction vessel of claim 4, wherein the solid phase is disposed in the lower portion of the reaction well below the vent tube such that the solid phase does not block-the vent opening.

6. The reaction vessel of claim 4, wherein the solid phase is immobilized in the upper portion of the reaction well above the vent opening such that the solid phase does not block the vent opening.

7. The reaction vessel of claim 1, wherein the funnel cap is configured so as to substantially prevent the escape of a liquid sample contained within the interior volume of the reaction well.

8. The reaction vessel of claim 7, wherein the solid phase is immobilized in the lower portion of the reaction well such that the solid phase does not block the vent passage.

9. The reaction vessel of claim 7, wherein the solid phase is disposed in the upper portion of the reaction well such that the solid phase does not block the vent passage.

10. The reaction vessel of claim 1, wherein the solid phase is directly disposed on at least a portion of the interior walls of the reaction wells, whereby the solid phase adheres to the at least portion of the interior walls of the reaction wells.

11. The reaction vessel of claim 10, wherein the solid phase is disposed on a lower portion of the interior walls of the reaction wells relative to the vent passage.

12. The reaction vessel of claim 10, wherein the solid phase is disposed on an upper portion of the interior walls of the reaction wells relative to the vent passage.

13. The reaction vessel of claim 10, wherein the solid phase covers the entire surface of the interior walls of the reaction wells below the vent passage.

14. The reaction vessel of claim 10, wherein the solid phase covers the entire surface of the interior walls of the reaction wells above the vent passage.

15. The reaction vessel of claim 1, further comprising an upper inert atmosphere cap configured so as to provide a constant positive pressure of inert gas while allowing for access to the reaction wells.

16. The reaction vessel of claim 15, wherein the solid phase is shaped to press fit into the funnel caps inserted into the open reaction wells.

17. The reaction vessel of claim 15, wherein the solid phase is directly disposed on at least a portion of the interior walls of the reaction wells, whereby the solid phase adheres to the at least portion of the interior walls of the reaction wells.

18. The reaction vessel of claim 17, wherein the solid phase is disposed on a lower portion of the interior walls of the reaction wells relative to the vent passage.

19. The reaction vessel of claim 17, wherein the solid phase is disposed on an upper portion of the interior walls of the reaction wells relative to the vent passage.

20. The reaction vessel of claim 17, wherein the solid phase covers the entire surface of the interior walls of the reaction wells below the vent passage.

21. The reaction vessel of claim 17, wherein the solid phase covers the entire surface of the interior walls of the reaction wells above the vent passage.

22. A reaction vessel assembly comprising:
a lower microplate assembly having a rigid body comprising a plurality of open reaction wells disposed therein and a funnel vent associated with each open reaction well for at least partially sealing the open well while allowing for venting of the well; and
an upper inert atmosphere cap configured so as to provide a constant positive pressure of inert gas while allowing for access to the open reaction wells.

23. The reaction vessel of claim 22, wherein the funnel vent is configured so as to substantially prevent the escape of a liquid sample contained within an interior volume of the reaction well.

24. A reaction vessel assembly comprising:
a microplate having a rigid body with a plurality of open reaction wells disposed therein, each of said open reaction wells comprising a fluid vessel with an opening and an interior volume with a sample-holding space located therein and a solid phase disposed within the interior volume of each of the reaction wells, wherein the solid phase is directly disposed on at least a portion of the interior walls of the reaction wells, and whereby the solid phase adheres to the at least portion of the interior walls of the reaction wells.

25. The reaction vessel of claim 24, wherein the solid phase is disposed on a lower portion of the interior walls of the reaction wells.

26. The reaction vessel of claim 24, wherein the solid phase is disposed on an upper portion of the interior walls of the reaction wells.

27. The reaction vessel of claim 24, wherein the solid phase substantially covers the entire surface of the interior walls of the reaction wells.

28. The reaction vessel of claim 24, further comprising an upper inert atmosphere cap configured so as to provide a constant positive pressure of inert gas while allowing for access to the reaction wells.

29. A method for performing a combination solution phase/solid phase reaction using the reaction vessel of claim 8 comprising the steps of:
(a) inserting solution phase reagents into the interior volume of the reaction well such that the solution phase reagent mixture is in contact with the solid phase; and
(b) allowing a solid phase reaction to proceed to form a product attached to the solid phase.

30. The method of claim 29, further comprising the steps of
(c) removing the solution phase mixture from the wells;
(d) introducing into the wells a solution capable of cleaving the product of the solid phase reaction from the solid phase and allowing for the cleavage of the product from the solid phase to proceed; and
(e) recovering the product cleaved from the solid phase.

31. A method for performing a catalyzed solution reaction using the reaction vessel of claim 8 comprising the steps of:
(a) inserting solution phase reagents into the interior volume of the reaction well
such that the solution phase reagent mixture is in contact with the solid phase; and
(b) allowing a solution phase reaction catalyzed by the solid phase to proceed to form a product in the solution phase.

32. A method for performing a solution phase reaction using the reaction vessel of claim 8 comprising the steps of:
(a) inserting solution phase reagents into the interior volume of the reaction well
such that the solution phase reagent mixture is in contact with the solid phase; and
(b) allowing a solution phase reaction to proceed to form a primary product and one or more secondary products; wherein at least one of the secondary products attaches to the solid phase; and
(c) separating the solution phase from the solid phase with one or more secondary products attached to the solid phase.

33. A method for performing a combination solution phase/solid phase reaction using the reaction vessel of claim 11 comprising the steps of:
(a) inserting solution phase reagents into the interior volume of the reaction well
such that the solution phase reagent mixture is in contact with the solid phase; and
(b) allowing a solid phase reaction to proceed to form a product attached to the solid phase.

34. The method of claim 33, further comprising the steps of
(c) removing the solution phase mixture from the wells;
(d) introducing into the wells a solution capable of cleaving the product of the solid phase reaction from the solid phase and allowing for the cleavage of the product from the solid phase to proceed; and
(e) recovering the product cleaved from the solid phase.

35. A method for performing a catalyzed solution reaction using the reaction vessel of claim 11 comprising the steps of:
(a) inserting solution phase reagents into the interior volume of the reaction well
such that the solution phase reagent mixture is in contact with the solid phase; and
(b) allowing a solution phase reaction catalyzed by the solid phase to proceed to form a product in the solution phase.

36. A method for performing a solution phase reaction using the reaction vessel of claim 11 comprising the steps of:
(a) inserting solution phase reagents into the interior volume of the reaction well
such that the solution phase reagent mixture is in contact with the solid phase; and
(b) allowing a solution phase reaction to proceed to form a primary product and one or more secondary products; wherein at least one of the secondary products attaches to the solid phase; and
(c) separating the solution phase from the solid phase with one or more secondary products attached to the solid phase.

37. A method for performing a combination solution phase/solid phase reaction using the reaction vessel of claim 18 comprising the steps of:
(a) inserting solution phase reagents into the interior volume of the reaction well
such that the solution phase reagent mixture is in contact with the solid phase adhered to the interior walls of the reaction wells; and
(b) allowing a solid phase reaction to proceed to form a product attached to the solid phase.

38. The method of claim 37, further comprising the steps of
(c) removing the solution phase mixture from the wells;
(d) introducing into the wells a solution capable of cleaving the product of the solid phase reaction from the solid phase and allowing for the cleavage of the product from the solid phase to proceed; and
(e) recovering the product cleaved from the solid phase.

39. A method for performing a catalyzed solution reaction using the reaction vessel of claim 18 comprising the steps of:
(a) inserting solution phase reagents into the interior volume of the reaction well
such that the solution phase reagent mixture is in contact with the solid phase; and
(b) allowing a solution phase reaction catalyzed by the solid phase to proceed to form a product in the solution phase.

40. A method for performing a solution phase reaction using the reaction vessel of claim 18 comprising the steps of:
(a) inserting solution phase reagents into the interior volume of the reaction well
such that the solution phase reagent mixture is in contact with the solid phase; and
(b) allowing a solution phase reaction to proceed to form a primary product and one or more secondary products; wherein at least one of the secondary products attaches to the solid phase; and
(c) separating the solution phase from the solid phase with one or more secondary products attached to the solid phase.

41. A method for performing a combination solution phase/solid phase reaction using the reaction vessel of claim 9 comprising the steps of:
(a) inserting starting material reagents into the interior volume of the reaction well and inverting the reaction vessel such that the reagents contact the solid phase;
(b) allowing a solid phase reaction to proceed to thereby form a solid phase product;
(c) turning the reaction vessel to an upright position such that the solution phase is no longer in contact with the solid phase;
(d) removing the solution phase from the reaction wells and introducing into the reaction wells a cleaving solution capable of separating the solid phase product from the solid phase;
(e) inverting the vessel such that the cleaving solution separates the product from the solid phase.

42. The method of claim 41, further comprising inverting the vessel after the separation of the solid phase product from the solid phase, introducing into the vessel a second reagent solution; and allowing a solution phase reaction to proceed between the solid phase product and the second solution reagent to form a solution phase product.

43. A method for performing a combination solution phase/solid phase reaction using the reaction vessel of claim 19 comprising the steps of:
(a) inserting starting material reagents into the interior volume of the reaction well and inverting the reaction vessel such that the reagents contact the solid phase;
(b) allowing a solid phase reaction to proceed to thereby form a solid phase product;
(c) turning the reaction vessel to an upright position such that the solution phase is no longer in contact with the solid phase;
(d) removing the solution phase from the reaction wells and introducing into the reaction wells a cleaving solution capable of separating the solid phase product from the solid phase;
(e) inverting the vessel such that the cleaving solution separates the product from the solid phase.

44. The method of claim 43, further comprising inverting the vessel after the separation of the solid phase product from the solid phase, introducing into the vessel a second reagent solution; and allowing a solution phase reaction to proceed between the solid phase product and the second solution reagent to form a solution phase product.
